(19) United States
(12) Patent Application Publication
(10) Pub. No.: US 2006/0064933 A1
(43) Pub. Date: Mar. 30, 2006

(54) Shutter

(76) Inventor: Zesao Chen, Irvine, CA (US)

Correspondence Address: BIRCH STEWART KOLASCH & BIRCH, PO BOX 747, FALLS CHURCH, VA, 22040-0747, US

(21) Appl. No.: 10/949,401

(22) Filed: Sep. 27, 2004

(51) Int. Cl. E06B 7/08

(52) U.S. Cl. 49/74.1

(57) ABSTRACT

A shutter mainly includes a first and a second fixing stile, and more than one louver. Both the first and the second fixing stile include a flange portion and a connection portion, and each of the louvers includes a rear portion, two lateral ends of which are rotatably connected to the connection portions of the first and the second fixing stile, and a front portion for blocking light.

### FIELD OF THE INVENTION

The present invention relates to a shutter, and more particularly to louvers and fixing stiles of a shutter.

### BACKGROUND OF THE INVENTION

A conventional shutter, as shown in FIG. 1, mainly includes a top rail 11, a bottom rail 12, a first fixing stile 13, a second fixing stile 14, and more than one louver 15. The first fixing stile 13 and the second fixing stile 14 are provided with connecting holes 131, 141, respectively. Each of the louvers 15 has symmetrical front and rear portions 151, 152 for blocking light, and is provided at two lateral ends with two rotate pins 153, 154 for rotatably engaging with the connecting holes 131, 141 on the first and the second fixing stile 13, 14.

Please refer to FIGS. 2 and 3 at the same time. To assemble the shutter, first fixedly mount the top rail 11, the bottom rail 12, the first fixing stile 13, and the second fixing stile 14, and then rotatably connecting the rotate pins 153, 154 at two lateral ends of each louver 15 to the connecting holes 131, 141 on the first and the second fixing stile 13, 14, and finally assemble a tilt rod 155 to the louvers 15 by engaging openings 155a provided on the tilt rod 155 with staples 155b correspondingly provided on the louvers 15. The top rail 11 is provided at a predetermined position with a receiving recess 112. When the tilt rod 155 is moved upward, an upper end of the tilt rod 155 is moved into the receiving recess 112 of the top rail 11. Finally, hinges 133 are mounted between the first fixing stile 13 and the frame 16.

Please further refer to FIGS. 2 and 3. Since each of the louvers 15 has symmetrical front and rear portions 151, 152 for blocking light, the shutter with the louvers 15 could not be mounted in a window opening having a reduced overall depth. That is, the shutter with the louvers 15 could only be mounted in a window opening having an overall depth at least equal to a total distance of the louver 15 from the front portion 151 to the rear portion 152 and could not be reduced any further.

Moreover, as can be seen from FIG. 4, for the louver 15 to be more easily connected at two ends to the first and the second fixing stile 13, 14, a clearance 17 is left between each rotate pin 153, 154 of the louver 15 and each fixing stile 13, 14. And, the louvers 15 could not effectively block light passing through these clearances.

It is therefore tried by the inventor to develop an improved shutter to eliminate drawbacks existed in the conventional shutter.

### SUMMARY OF THE INVENTION

A primary object of the present invention is to provide a shutter that could be mounted in a window opening with a reduced overall depth.

Another object of the present invention is to provide a shutter that allows reduction of an overall depth of a window frame for mounting the shutter.

A further object of the present invention is to provide a shutter that effectively blocks light at joints of the louvers and the fixing stiles of the shutter.

A still further object of the present invention is to provide a shutter that provides enhanced structural strength at where the louvers are connected to the fixing stiles.

A still further object of the present invention is to provide a shutter, of which the louvers could be fabricated at reduced cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional shutter;

FIG. 2 is an assembled perspective view of the conventional shutter of FIG. 1 with louvers thereof in an opened position;

FIG. 3 is an assembled perspective view of the conventional shutter of FIG. 1 with louvers thereof in a closed position;

FIG. 4 is a top sectional view of FIG. 3;

FIG. 5 is an exploded perspective view of a shutter according to a preferred embodiment of the present invention;

FIG. 6 is an assembled perspective view of the shutter of FIG. 5 with louvers thereof in an opened position;

FIG. 7 is an assembled perspective view of the shutter of FIG. 6 with louvers thereof in a closed position; and

FIG. 8 is a top sectional view of FIG. 7.

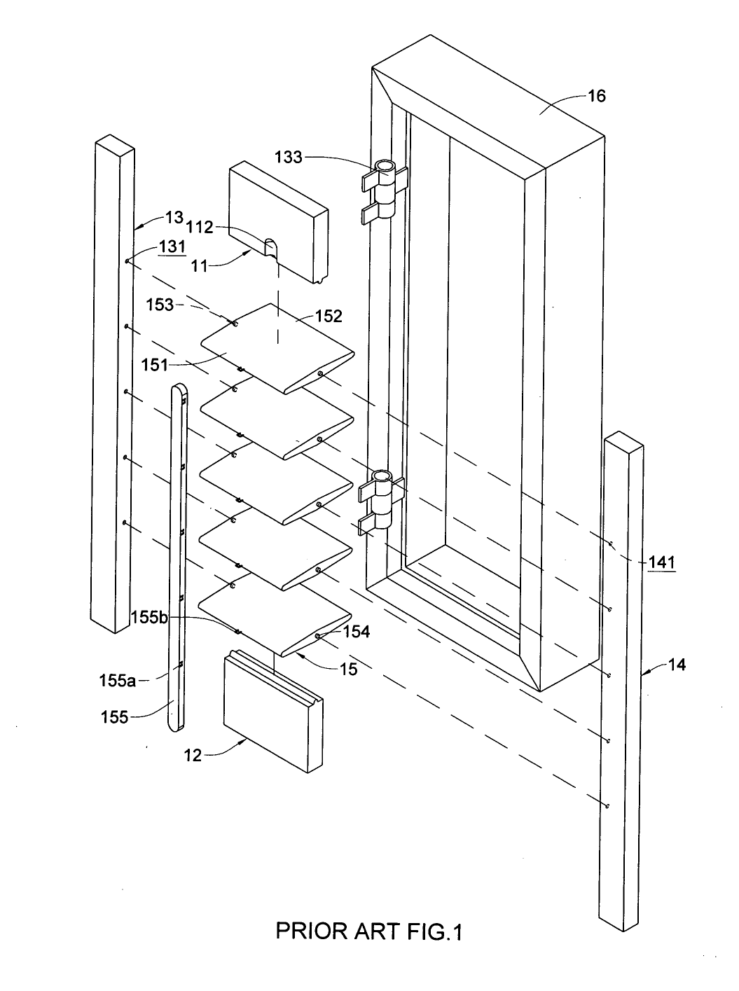

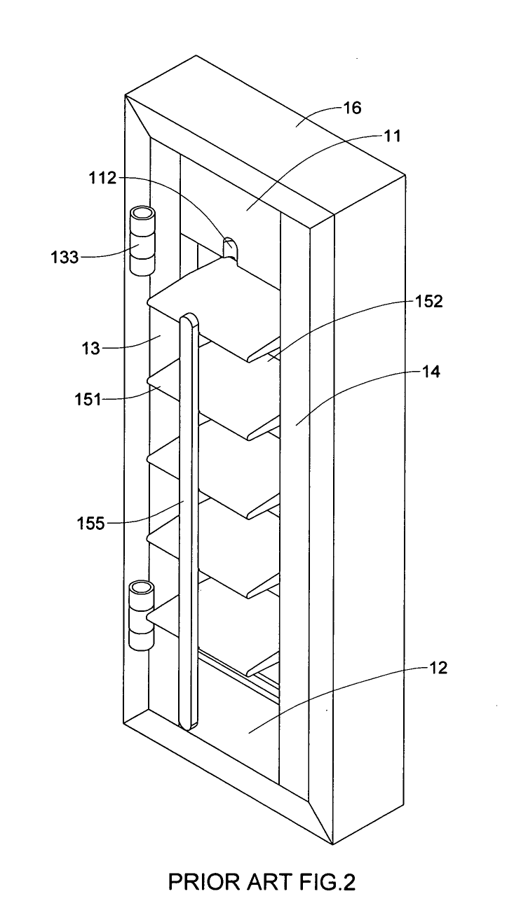

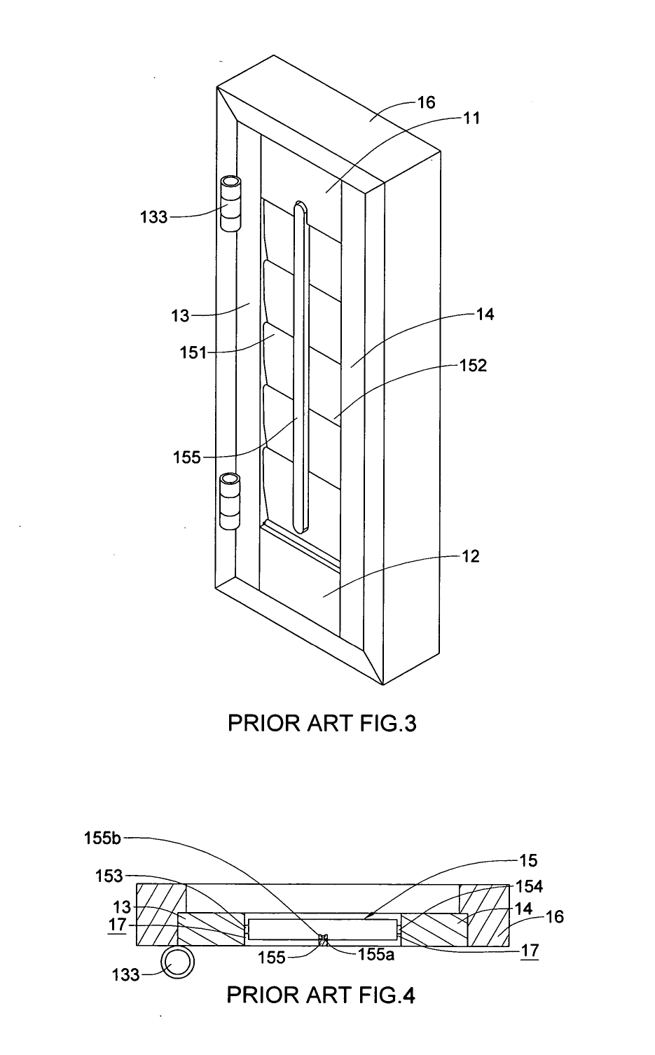

### DETAILED DESCRIPTION OF THE PREFERRED EMBODIMENTS

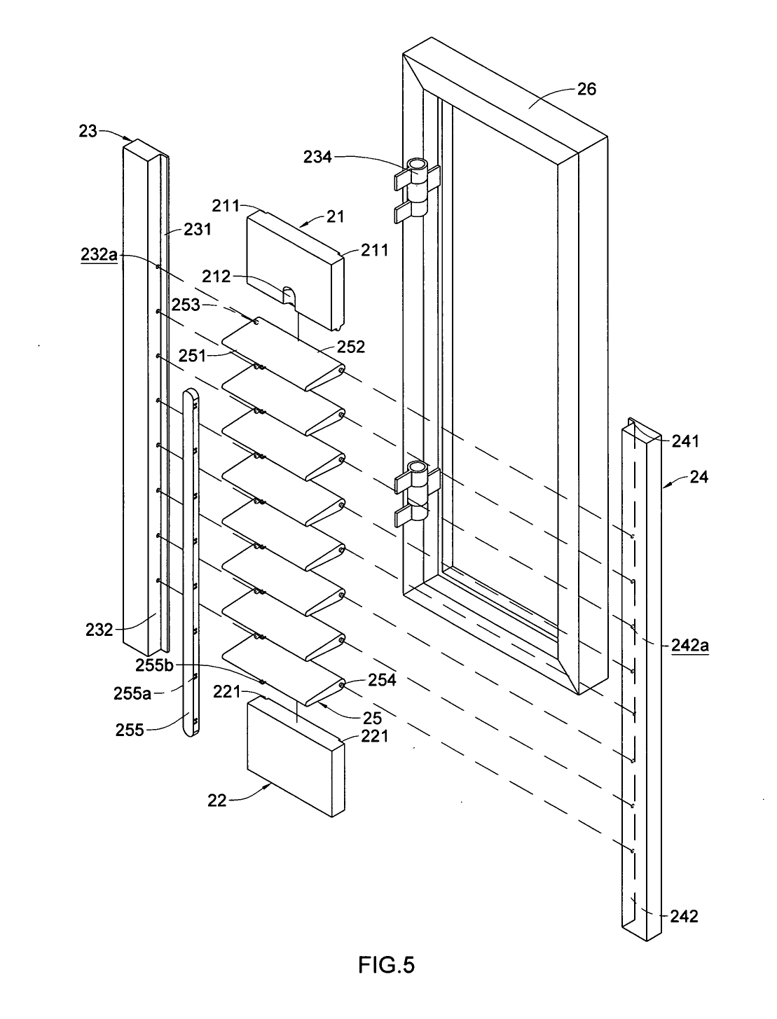

Please refer to FIG. 5 that is an exploded perspective view of a shutter according to a preferred embodiment of the present invention. As shown, the shutter mainly includes a top rail 21, a bottom rail 22, a first fixing stile 23, a second fixing stile 24, and more than one louver 25. Both the first and the second fixing stile 23, 24 include a flange portion 231, 241, respectively, and a connection portion 232, 242, respectively. Each of the louvers 25 includes a rear portion 252, two lateral ends of which are connected to the connection portions 232, 242 of the first and the second fixing stile 23, 24, respectively, and a front portion 251 for blocking light.

The connection portions 232, 242 of the first and the second fixing stile 23, 24 are provided with spaced holes 232a, 242a, respectively. And, the rear portion 252 of the louver 25 is provided at the two lateral ends with rotate pins 253, 254 adapted to rotatably engage with the holes 232a, 242a on the first and the second fixing stile 23, 24, respectively.

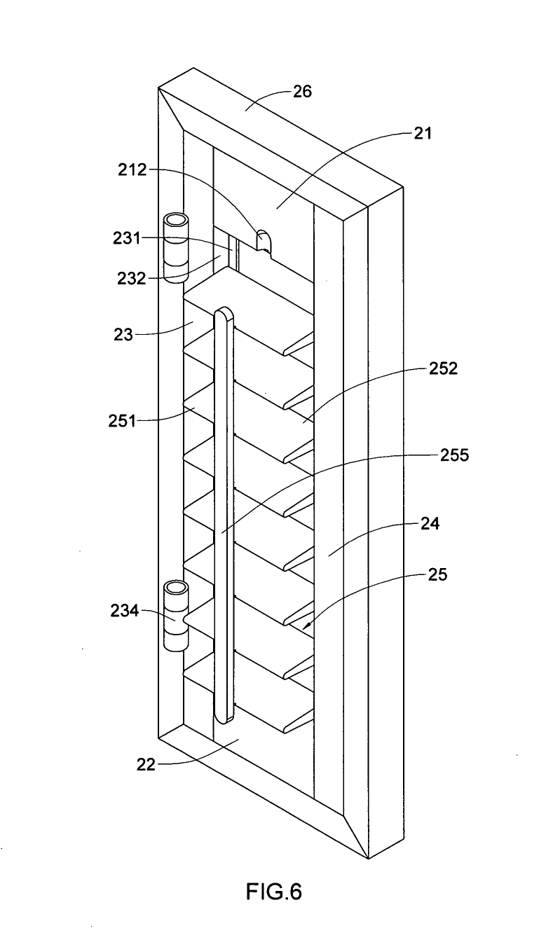

Please refer to FIGS. 5 and 6 at the same time. To erect the shutter of the present invention, first engage female connectors 211 provided at two lateral sides of the top rail 21 with the flange portions 231, 241 of the first and the second fixing stile 23, 24, respectively, and then engage female connectors 221 provided at two lateral sides of the bottom rail 22 with the flange portions 231, 241 of the first and the second fixing stile 23, 24, respectively. (The female connectors 211, 221 provided on the top rail 21 and the bottom rail 22, respectively, and the flange portion 231, 241 of the first and the second fixing stile 23, 24, respectively, may be engaged with and connected to one another by means of bonding.)

Thereafter, fixedly mount the top and the bottom rail 21, 22, and the first and the second fixing stile 23, 24 in a frame 26, mount the more than one louver 25 by rotatably engaging the rotate pins 253, 254 at two lateral ends of the rear portion 252 of the louver 25 with the holes 232a, 242a on the connection portions 232, 242 of the first and the second fixing stile 23, 24, respectively, and assemble a tilt rod 255 to the louvers 25 by engaging openings 255a provided on the tilt rod 255 with staples 255b correspondingly provided on the louvers 25. The top rail 21 is provided at a predetermined position with a receiving recess 212. When the tilt rod 255 is moved upward, an upper end of the tilt rod 255 is moved into the receiving recess 212 of the top rail 21. Finally, hinges 234 are mounted between the first fixing stile 23 and the frame 26.

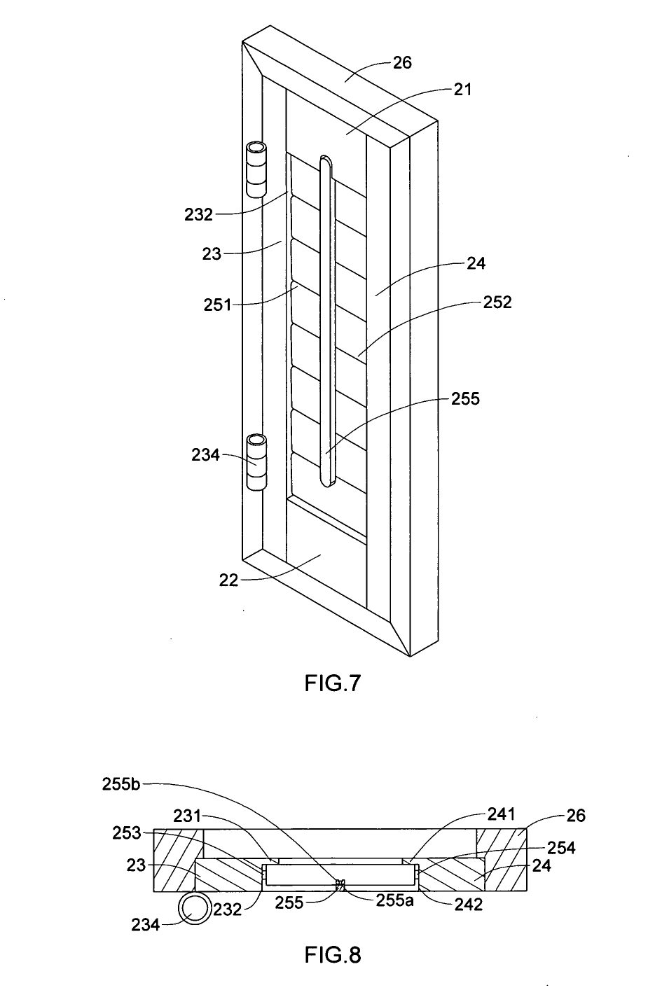

Please refer to FIG. 5 and to FIGS. 6 and 7 that are assembled perspective views of the shutter of the present invention with the more than one louver 25 in opened and closed positions, respectively. Since a distance from the rotate pins 253, 254 of the louver 25 to a rear edge of the rear portion 252 of the louver 25 is reduced in comparison with the louver 15 for the conventional shutter, and smaller than a distance from the rotate pins 253, 254 to a front edge of the front portion 251, an overall depth of the louver 25 between the rear and the front edges of the louver 25 is smaller than the overall depth of the conventional louver 15. Therefore, the shutter of the present invention with louvers 25 having a reduced overall depth could be erected in a frame 26 having a reduced overall depth. Correspondingly, the frame 26 for supporting the shutter of the present invention may have a small overall depth substantially equal to the distance from the rotate pins 253, 254 of the louver 25 to the front edge of the front portion 251 of the louver 25.

In another embodiment of the present invention, the distance from the rotate pins 253, 254 of the louver 25 to the front edge of the front portion 251 of the louver 25 is the same as the overall depth of the conventional louver 15 covering the front portion 151 and the rear portion 152 to provide the same light blocking effect as the conventional louver 15.

Please refer to FIG. 8 that is a top sectional view of the shutter of the present invention. As shown, after the louvers 25 are connected at two lateral ends to the first and the second fixing stiles 23, 24, a clearance exists at each joint of the rotate pin 253, 254 at each lateral end of the more than one louver 25 and each fixing stile 23, 24. However, the flange portions 231, 241 of the first and the second fixing stile 23, 24, respectively, have an inward extended length long enough to cover the clearances between the connection portions 232, 242 of the fixing stiles 23, 24 and the lateral ends of the louvers 25 to effectively block light at two lateral ends of the louvers 25.

It is noted the holes 232a, 242a provided on the two connection portions 232, 242 of the first and the second fixing stile 23, 24, respectively, may be equally spaced or unequally spaced.

The following are some advantages of the present invention:
1. While clearances are provided at two lateral ends of the louvers to enable smooth opening and closing of the louvers relative to the two fixing stiles, the flange portions 231, 241 on the first and the second fixing stile 23, 24 of the shutter of the present invention could effectively block light at these clearances. The flange portions 231, 241 also allow the louvers 25 to more firmly connect to the connection portions 232, 242.
2. The distance from the rotate pins 253, 254 of the louver 25 to the rear edge thereof is reduced to enable a lowered manufacturing cost of the louver 25 and mounting of the louvers 25 in a frame 26 having a reduced depth.
3. With the reduced distance of the louver 25 between the rotate pins 253, 254 and the rear edge, it is possible for a window opening for mounting the shutter to have a reduced depth.
4. It is also possible for the distance of the louver 25 from the rotate pins 253, 254 to the front edge of the front portion 251 to be equal to an overall depth of the conventional louver 15 covering the front portion 151 and the rear portion 152, so that the shutter of the present invention provides the same light-blocking effect as the conventional louvers 15 do, and may still be mounted in the frame 26 having a reduced overall depth.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A shutter, comprising a first fixing stile, a second fixing stile, and more than one louver; both said first and said second fixing stile including an inward extended flange portion and a connection portion; and said louver including a rear portion for rotatably connecting at two lateral ends to said connection portions of said first and said second fixing stile, and a front portion for blocking light.

2. The shutter as claimed in claim 1, wherein said connection portions of said first and second fixing stiles are provided with holes.

3. The shutter as claimed in claim 2, wherein said holes provided on said first and said second fixing stile are equally spaced.

4. The shutter as claimed in claim 1, wherein said rear portion of said louver is provided at two lateral ends with two rotate pins.

5. The shutter as claimed in claim 1, wherein said louver is provided at a predetermined position with a staple for engaging with an opening correspondingly provided on a tilt rod.

6. A shutter, comprising a top rail, a bottom rail, a first fixing stile, a second fixing stile, and more than one louver; said top and said bottom rail being connected at respective two lateral ends to upper ends of said first and said second fixing stile and lower ends of said first and said second fixing stile, respectively; both said first and said second fixing stile including an inward extended flange portion and a connection portion; and said louver including a rear portion for rotatably connecting at two lateral ends to said connection portions of said first and said second fixing stile, and a front portion for blocking light.

7. The shutter as claimed in claim 6, wherein said connection portions of said first and second fixing stiles are provided with holes.

8. The shutter as claimed in claim 7, wherein said holes provided on said first and said second fixing stile are equally spaced.

9. The shutter as claimed in claim 6, wherein said rear portion of said louver is provided at two lateral ends with two rotate pins.

10. The shutter as claimed in claim 6, wherein said louver is provided at a predetermined position with a staple for engaging with an opening correspondingly provided on a tilt rod.

11. The shutter as claimed in claim 6, wherein said top rail is provided at a predetermined position with a receiving recess.

12. A shutter, comprising a top rail, a bottom rail, a frame, a first fixing stile, a second fixing stile, and more than one louver; said top and said bottom rail being connected at respective two lateral ends to upper ends of said first and said second fixing stile and lower ends of said first and said second fixing stile, respectively; said top rail, said bottom rail, said first fixing stile, and said second fixing stile being mounted in said frame; both said first and said second fixing stile including an inward extended flange portion and a connection portion; and said louver including a rear portion for rotatably connecting at two lateral ends to said connection portions of said first and said second fixing stile, and a front portion for blocking light.

13. The shutter as claimed in claim 12, wherein said connection portions of said first and second fixing stiles are provided with holes.

14. The shutter as claimed in claim 12, wherein said rear portion of said louver is provided at two lateral ends with two rotate pins.

15. The shutter as claimed in claim 12, wherein said louver is provided at a predetermined position with a staple for engaging with an opening correspondingly provided on a tilt rod.

16. The shutter as claimed in claim 12, wherein said top rail is provided with at a predetermined position with a receiving recess.

17. The shutter as claimed in claim 12, wherein said first fixing stile is connected to said frame via hinges.
